(19) United States
(12) Patent Application Publication
(10) Pub. No.: US 2026/0281721 A1
(43) Pub. Date: Sep. 17, 2026

(54) SIM-BASED REGISTRATION MANAGEMENT SYSTEM

(71) Applicant: T-Mobile Innovations LLC, Overland Park, KS (US)

(72) Inventors: Kulandaivel MARAPPA GOUNDER, Bothell, WA (US); Kevin AN, Sammamish, WA (US); Nilesh RANJAN, Sammamish, WA (US)

(21) Appl. No.: 19/078,762

(22) Filed: Mar. 13, 2025

(51) Int. Cl. H04W 12/06; H04W 4/029; H04W 12/63; H04W 60/00

(52) U.S. Cl. CPC H04W 12/06; H04W 4/029; H04W 12/63; H04W 60/00

(57) ABSTRACT

Systems and methods are provided for managing network acquisition. A wireless device receives an authentication request for a private network and determines a location (TAC/LAC) of the wireless device. It is determined whether the location of the wireless device is on a list of allowed or disallowed locations from a subscriber identification module (SIM) of the wireless device. In response to determining that the location of the wireless device is not listed as an allowed location or is a disallowed location, ignoring the authentication request from the private network.

### TECHNICAL BACKGROUND

Different types of networks can include wireless communication networks, packet-switched networks such as public/private networks enabling communication between wireless devices. One type of communication network described herein includes telecommunications networks, such as 5G New Radio (NR) networks, 4G LTE networks, etc.

Despite powerful LTE and 5G wireless networks, Mobile Network Operators (MNO) have experienced the need to optimize unnecessary load on their network. Undesirable and unsuitable requests for access to the network are typically not filtered out and removed by setting proper criteria and requirements.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts an exemplary system for wireless communication, in accordance with the disclosed examples.

FIG. 2 illustrates an exemplary wireless device in accordance with the disclosed examples.

FIG. 3 illustrates an exemplary wireless device in accordance with the disclosed examples.

FIG. 4 depicts an exemplary system for network registration management, in accordance with the disclosed examples.

FIG. 5 depicts a flowchart illustrating an exemplary method for controlling SIM request for access to a public land mobile network (PLMN), in accordance with the disclosed examples.

### OVERVIEW

Various aspects of the present disclosure relate to systems, methods and computer readable media for controlling access to a network, such as a public land mobile network (PLMN).

Methods, systems and computer readable medium are provided for receiving, at a wireless device, an authentication request for a private network; determining a location of the wireless device; determining whether the location of the wireless device is on a list of allowed or disallowed locations from a subscriber identification module (SIM) of the wireless device; and in response to determining that the location of the wireless device is not listed as an allowed location or is a disallowed location, ignoring the authentication request from the private network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may contain an electronic processor included in a wireless device.

A private wireless network is a discrete, customized cellular network that is not connected to the public cellular network. A private network may have dedicated resources, such as network infrastructure, core and/or spectrum. Private networks provide secure limited access to only certain users, such as members or employees of a business enterprise. Private wireless networks segregate traffic from the public macro network and can provide lower latency and higher bandwidth greater efficiencies, reliability, safety, and security.

However, different private wireless networks may be allocated to the same Mobile Country Code (MCC)-Mobile Network Code (MNC) causing a wireless device of a private wireless network to attempt to attach to other private network with the same MCC-MNC. Even though each private network may have its own core, the wireless devices attempt to attach with other private networks if it is within the coverage area. In addition, a wireless device may attempt to attach to areas of a private network that they are not authorized to access. The futile and wasteful attempts increase unnecessary load on the wireless device and the network.

To prevent unnecessary attempts to attach to the incorrect private wireless network, a subscriber identification module (SIM) operating system (OS) interacts with a wireless device to direct the wireless device to the proper private network. For example, the SIM OS may maintain a list of allowed and disallowed private networks.

The SIM may be a removable SIM or an eSIM. A SIM is manufactured or configured so that the SIM profile includes a list of allowed and disallowed locations, such as private networks. Each private network may be uniquely identified by a combination of Mobile Country Code (MCC) and Mobile Network Code (MNC). The MCC identifies the country, while the MNC identifies the specific mobile network operator within that country. Additional unique areas of coverage within the MCC-MNC are identified with Tracking Area Code (TAC) and Location Area Code (LAC). TAC/LAC are identifiers that manage and track the location of mobile devices as they move between different areas within the network coverage.

For a wireless device subscribed to a private network, the SIM profile includes a list of allowed and/or disallowed private networks based on location, such as TAC/LAC IDs. When attempting to attach to the network, the SIM OS reads the list of allowed and disallowed location IDs, such as TAC/LAC IDs, from the SIM profile to determine whether the location ID being broadcast is an allowed or disallowed location, such as a TAC/LAC ID. If the location (TAC/LAC ID) belongs to a disallowed list, the SIM OS aborts communication between the SIM and the location (TAC/LAC ID), and the SIM does not request to attach to the location (TAC/LAC ID). If the list includes the broadcasted location (TAC/LAC ID), the SIM sends a request to attach to the allowed location (TAC/LAC ID).

The SIM-based network registration management system filters out inaccessible private networks based on the location, minimizing requests to attach to other inaccessible private networks and optimizing the load on network and the wireless device.

A wireless network, such as a cellular network, can include a core network and a radio access network (RAN) serving multiple wireless devices in a geographical area covered by a radio frequency transmission provided by the access network. Different carriers within the cellular network may utilize different types of radio access technologies (RATs). RATs can include, for example, third generation (3G) RATs (e.g., WCDMA, UMTS, CDMA etc.), fourth generation (4G) RATs (e.g., WiMax, Long Term Evolution (LTE), etc.), and fifth generation (5G) RATs (new radio (NR)), 6G and non-terrestrial networks. Further, different types of access nodes may be implemented within the access network for deployment for the various RATs. For example, an evolved NodeB (eNB) may be utilized for 4G RATs and a next generation NodeB (gNB) may be utilized for 5G RATs. Deployment of the evolving RATs in a network provides numerous benefits. For example, newer RATs may provide additional resources to subscribers, faster communications speeds, and other advantages.

As access nodes have evolved, networks may include a combination of multiple access nodes such as 4G LTE eNBs and 5G NR next generation gNBs or alternatively may be 4G or 5G cellular systems. The evolution of 5G RATs has resulted in significant network architectural developments. For example, the 5G core network offers a serviced based architecture (SBA). The 5G core network is delivered through a set of interconnected network functions (NFs). The NFs are able to access the services of the other NFs in the core network. This is contrast to the 4G LTE evolved packet core (EPC), which implements a fixed-function, hard-wired architecture

The attach procedure may occur when a subscriber moves location, a subscriber switches on a UE or when a subscriber switches airplane mode off on their mobile phone. The UE antenna receives advertisements from the different access nodes in the area. The UE uses information in the access node advertisements to select the most suitable access node.

When UEs from different private NW are allocated the same MCC-MNC code for private NW providers, the UE will continue to attempt to attach to other private network operators within the coverage area. This will increase unnecessary load on RAN and the private network core. By adding location information, such as TAC/LAC, to an allowed and/or blocked list in special file location in the SIM of the UE, unnecessary attachment attempts on other private networks can be prevented.

In one example, the SIM OS of the UE checks if a broadcasted location, such as TAC/LAC, is on a blocked list, and if so, the SIM OS will not attempt to attach to the access node. In another example, the SIM OS of the UE checks to if a broadcasted location, such as TAC/LAC, is on an allowed list, and if not, the SIM OS will not attempt to attach to the access node.

The SIM OS includes an allowed/blocked file of permitted and/or blocked locations. The UE may read the allowed/blocked file location and make a decision. In an example, the location allowed range includes MCC-MNC-TAC-CELL-ID-1 to MCC-MNC-TAC-CELL-ID-10 and the Blocked Range includes MCC-MNC-TAC-CELL-ID-10 to MCC-MNC-TAC-CELL-ID-20. The SIM of the UE may be configured to block/allow a specific MCC-MNC-TAC-CELL-ID range. If the location is on the blocked list, then the SIM OS drops the request and does not attempt to attach. If the location is not in the blocked list or is in the allowed list, then the UE proceeds with a normal attach/registration procedure.

Turning now to the figures, various devices, systems, and methods in accordance with aspects of the present disclosure will be described.

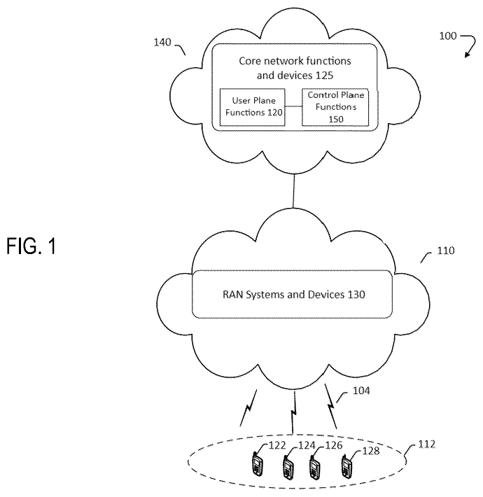

FIG. 1 depicts an exemplary SIM-based network registration management system 100 for wireless communication, in accordance with the disclosed embodiments. The system 100 may include a core network 140, a radio access network (RAN) 110 and multiple wireless devices 122, 124, 126, and 128 able to communicate within the network. The wireless devices 122, 124, 126, and 128 include a SIM operating system (SIM OS), and may operate within one or more coverage areas 112 and communicate with the RAN 110 over communication links 104, which may, for example, be 5G NR communication links, 6G communication links, 4G LTE communication links, or any other suitable type of communication link.

The core network 140 includes core network functions and devices 125. The core network may have an evolved packet core (EPC) structure or may be structured using a service-based architecture (SBA). The network functions and devices 125 may be separated into user plane functions 120 and control plane functions 150. In an SBA architecture, service-based interfaces may be utilized between control-plane functions, while user-plane functions connect over point-to-point links.

The RAN systems and devices 130 may include various access network systems and devices 130. The RAN systems and devices 130 are disposed between the core network 140 and the wireless devices 122, 124, 126, 128.

The RAN 110 includes at least an access node (or base station), such as an eNodeB, a next generation NodeB (gNodeB) communicating with a plurality of end-user wireless devices. It is understood that the disclosed technology may also be applied to communication between a wireless device and other network resources, such as relay nodes, controller nodes, antennas, etc. Further, multiple access nodes may be utilized. For example, some wireless devices may communicate with an LTE eNB and others may communicate with an NR gNB.

Access nodes can be, for example, standard access nodes such as a macro-cell access node, a base transceiver station, a radio base station, an eNB device, an enhanced eNB device, a next generation NodeB (or gNB) in 5G New Radio (“5G NR”), or the like. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

Access nodes can be configured to deploy at least two different carriers, each of which utilizes a different RAT. For example, a first carrier may be deployed by an access node in an LTE mode, and a second carrier may be deployed by an access node in an NR mode. Thus, in an embodiment, the access node may comprise two co-located cells, or antenna/transceiver combinations that are mounted on the same structure. In some embodiments, multiple access nodes may be deployed and each access node may support a different RAT. For example, a gNodeB may support NR and an eNodeB may provide LTE coverage. Any other combination of access nodes and carriers deployed therefrom may be evident to those having ordinary skill in the art in light of this disclosure.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Wireless devices 122, 124, 126, and 128 having a SIM OS may be any device, system, combination of devices, or other such communication platform capable of communicating wirelessly with RAN 110 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, as well as other types of devices or systems that can send and receive audio or data. The wireless devices may be or include high power wireless devices or standard power wireless devices. The wireless devices may further include Internet of Things (IoT) devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices of SIMs 122, 124, 126, and 128. Wireless network protocols may include one or more of Multimedia Broadcast Multicast Services (MBMS), code division multiple access (CDMA) 1xRTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), Fifth Generation mobile networks or wireless systems (5G, 5G New Radio (“5G NR”), or 5G LTE) and Sixth Generation mobile networks (6G). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 110 and the core network 140.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

The operations for overhead reduction may be implemented as computer-readable instructions or methods, and processing nodes on the network for executing the instructions or methods. The processing node may include a processor included in the access node or a processor included in any controller node in the wireless network that is coupled to the access node.

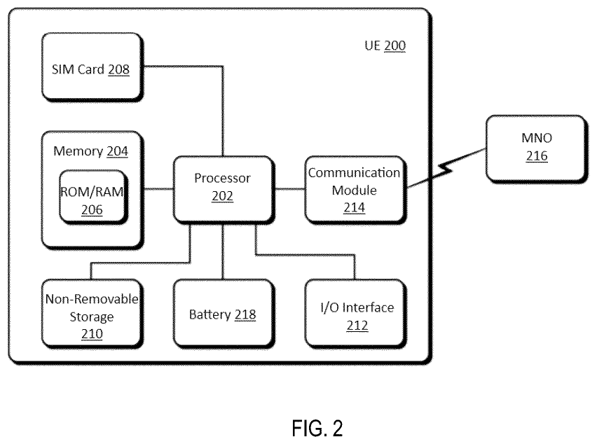

FIG. 2 illustrates an example block diagram of a wireless device. The wireless device 200 may include one or more processors 202 and memory 204 coupled to the one or more processors 202. In some examples, the one or more processors 202 may be a central processing unit (CPU), a graphics processing unit (GPU), or both CPU and GPU, or other processing unit or component known in the art. Memory 204 may include volatile memory (such as random-access memory (RAM)) and/or non-volatile memory (such as read-only memory (ROM), flash memory, etc.) 206. The wireless device 200 may include SIM 208 coupled to the one or more processors 202, and non-removable storage 210 including, but not limited to, flash memory, magnetic storage, optical storage, and/or tape storage that may provide non-volatile storage of computer readable instructions, data structures, program modules, and other data for the wireless device 200.

The wireless device 200 may include an Input/Output (I/O) interface 212 coupled to the one or more processors 202 and may include a touch screen, microphone, and the like, configured to receive information from a user, and may include an audio output. The display is configured to provide an output for the user. The wireless device 200 may include a communication module 214 coupled to the one or more processors 202 and configured to wirelessly communicate with a MNO 216. Communication module 214 is configured to wirelessly communicate with the network. The wireless device 200 may also include a battery 218 configured to power all components of the wireless device 200.

Memory 204, a non-transitory computer storage medium, may store computer-readable instructions executable by the one or more processors 202, that when executed by the one or more processors 202, cause the one or more processors 202 to perform the required operations. Some or all operations of the methods described above can be performed by execution of computer-readable instructions stored on a computer-readable storage medium.

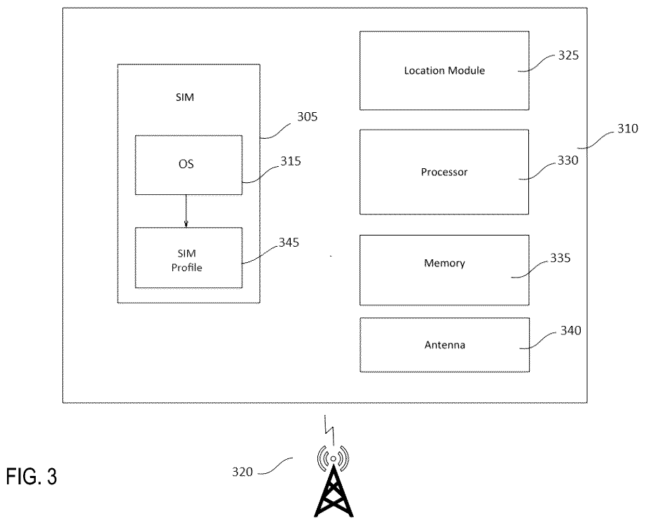

Referring next to FIG. 3, wireless device 310 may be a wireless communication device having a SIM 305, location module 325, processor 330, memory 335, and antenna 340.

The wireless device 110 may include one or more processors 330 and memory 335 coupled to the one or more processors 330. Further, wireless device 110 may include antenna 340. Antenna 340 may be a radio frequency (RF) antenna, coupled to processor 330. Antenna 340 transmits and receives RF signals. Antenna 340 is capable of transmitting and receiving RF signals from network 320.

Location module 325 determines the location of wireless device 310. Location module 325 may utilize GPS, antenna patterns, communication patterns, Bluetooth, Wifi and combinations thereof to determine the location of wireless device 310.

SIM 305 may be a SIM or module. SIM 305 is an integrated circuit (IC) intended to securely store the international mobile subscriber identity (IMSI) number and its related key and is used to identify and authenticate subscribers on wireless device 310.

SIM 305 comprises wireless communication service provider data and wireless communication service subscriber data. Exemplary SIM may comprise a universal integrated circuit card (UICC) or an embedded universal integrated circuit card (eUICC).

SIM 305 may include an operating system (OS) 315 and a SIM profile 320. SIM OS 315 is the operating system and manages its core functions. SIM OS 315 manages the authentication process between the wireless device 310 and network 320, ensuring that authorized users can access the network 320. SIM OS 315 includes a file system structure to organize and manage data stored on the SIM 305. This file system includes files and directories for different types of information and applications.

SIM profile 345 is a set of data and configurations stored on a SIM 305, enabling the SIM 305 to function within the network 320. In one embodiment, SIM profile 345 includes a network list, which includes blocked and/or allowed location. The location, such as TAC/LAC, may be pre-configured upon manufacture or may be configured at activation of the SIM.

SIM 305 may further comprise a phone number (IMSI), an international mobile equipment identifier (IMEI), or/and a network identity (e.g., a public land mobile network (PLMN) identity). SIM 305 may comprise one or more sets of executable instructions and/or applications. SIM OS 315 may be used for execution of the instructions and programs stored on SIM 305.

In one embodiment, the wireless device 310 attempts to attach to a private network if the location is on the allowed list of SIM 305. The wireless device will not attempt to attach to a private network if the location is on a disallowed list of SIM 305.

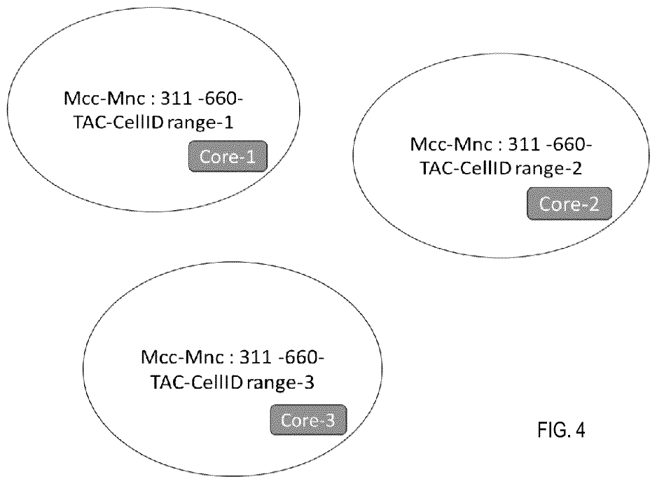

FIG. 4 illustrates exemplary private networks each having a separate core. In embodiment, each private network has the same MCC-MNC code. Each private network is identified by a TAC-Cell ID range, that includes a range of TAC ID numbers. For example, core network 1 covers TAC Cell ID numbers 1-10, core network 2 covers TAC Cell ID numbers 11-20, and core network 3 covers TAC Cell ID numbers 21-30. A person of ordinary skill in the art would appreciate that LAC Cell ID numbers could be used instead.

In another embodiment, SIM profile 345 of the SIM 305 includes a list of allowed locations such as TAC/LAC IDs (or in the alternative prohibited TAC/LAC IDs). The SIM 305 may be configured by the MNO to include sets of locations such as TAC/LAC IDs. In the example shown in FIG. 4, TAC Cell ID numbers 11-20 are included in the SIM profile 345 as allowed, and TAC Cell ID numbers 1-10 and 21-30 are prohibited. In an instance where the wireless device 310 is within the network coverage of each private network, each private network would broadcast availability of the core network to the wireless device 310. However, instead of automatically attempting to attach to all three core networks 1-3, SIM OS 315 compares the broadcast location of each of the core networks 1-3 to the network list of SIM profile 345. Specifically, SIM OS 315 may read the list of allowed (or prohibited, depending on the use case) location IDs from the list stored in the SIM profile 345. The SIM OS 315 compares the location IDs (TAC/LAC IDs) being broadcast from one or more of the private networks to determine whether the location IDs (TAC/LAC IDs) belong to the allowed (or blocked) list stored in the SIM profile 345.

In one embodiment, for the location IDs (TAC/LAC IDs) from private network 1 are on the allowed on the list and the SIM OS 315 sends instructions to the SIM 305 of the wireless device 310 to attempt to attach to the network 320. Private networks 2 and 3 are not on the allowed list (or are on the disallowed list) so the SIM 305 will not attempt to attach to core networks 2 and 3.

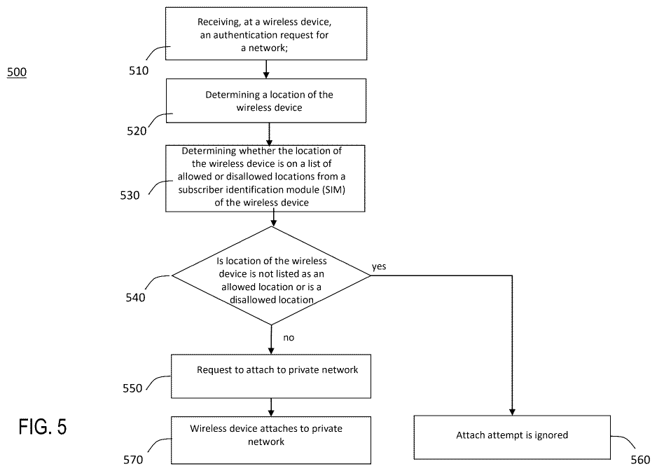

FIG. 5 illustrates an exemplary process flow 500 controlling access to a network. The operations of FIG. 5 will be described as being performed by the SIM OS 315 of wireless device 310 for purposes of explanation. In other implementations, the operations may be performed by or under the control of a processor external SIM of wireless device 310. Generally, the process flow may be implemented using a wireless device that is capable of using network for cellular communication.

The process flow begins at operation 510, receiving, at a wireless device, an authentication request for a network. The authentication request is broadcast by an access node of the network. At operation 520, a location of the wireless device is determined. The location of the wireless device is determined from the location ID in the authentication request broadcast by the access node.

At operation 530, the SIM OS determines whether the location of the wireless device is on a list of allowed or disallowed locations from a subscriber identification module (SIM) of the wireless device. For example, the SIM OS determines whether the TAC/LAC ID is on a list of allowed or disallowed locations stored on the SIM. At operation 540, in response to determining that the location of the wireless device is not listed as an allowed location or is a disallowed location, the process flow proceeds to operation 560.

At operation 560, the authentication request from the access node is ignored. In one example, in addition to ignoring the authentication request for the location ID, such as the TAC/LAC ID, the SIM prevents future attempts at authentication by the access node broadcasting that location ID.

Alternatively, at operation 540, in response to determining that the location of the wireless device is listed as an allowed location or is a not a disallowed location, the process flow proceeds to operation 550. At operation 550, the wireless device proceeds with requesting attachment to the location, such as the TAC/LAC ID for a private network. At operation 570, the wireless device attaches to the location, such as the TAC/LAC ID for a private network.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A method, comprising:
receiving, at a wireless device, an authentication request for a private network;
determining a location of the wireless device;
determining whether the location of the wireless device is on a list of allowed or disallowed locations from a subscriber identification module (SIM) of the wireless device; and
in response to determining that the location of the wireless device is not listed as an allowed location or is listed as a disallowed location, ignoring the authentication request from the private network.

2. The method of claim 1, further comprising:
in response to determining that the location of the wireless device is not listed as an allowed location, providing instructions to the SIM to abort communication with the private network.

3. The method of claim 1, wherein the private network is provides secure limited access to wireless devices of a business enterprise.

4. The method of claim 1, wherein the list of allowed or disallowed locations are Tracking Area Code/Location Area Code (TAC/LAC) identifiers within the private network.

5. The method of claim 1, wherein the list of allowed or disallowed locations includes two or more of a Mobile Country Code (MCC), Mobile Network Code (MNC) tracking area code (TAC), and location area code (LAC) identifiers.

6. The method of claim 1, wherein the SIM is a removable SIM.

7. The method of claim 1, wherein the private network has a private core separate from a public core.

8. The method of claim 2, wherein aborting the communication with the private network precludes the wireless device from attempting to attach to the private network.

9. The method of claim 2, wherein aborting the communication with the private network prevents the wireless device from requesting a Radio Access Network (RAN) to connect the wireless device to the private network.

10. A non-transitory computer-readable medium storing instructions that when executed by a processor cause the processor to perform operations comprising:
receiving, at a wireless device, an authentication request for a private network;
determining a location of the wireless device;
determining whether the location of the wireless device is on a list of allowed or disallowed locations from a subscriber identification module (SIM) of the wireless device; and
in response to determining that the location of the wireless device is not listed as an allowed location or is listed as a disallowed location, ignoring the authentication request from the private network.

11. The non-transitory computer-readable medium of claim 10, the operations further comprising:
in response to determining that the location of the wireless device is not listed as an allowed location, providing instructions to the SIM to abort communication with the private network.

12. The non-transitory computer-readable medium of claim 10, wherein the private network provides secure limited access to certain wireless devices of a enterprise.

13. The non-transitory computer-readable medium of claim 10, wherein the list of allowed or disallowed locations are Tracking Area Code/Location Area Code (TAC/LAC) identifiers within the private network.

14. The non-transitory computer-readable medium of claim 10, wherein the list of allowed or disallowed locations includes two or more of a Mobile Country Code (MCC), Mobile Network Code (MNC) tracking area code (TAC), and location area code (LAC) identifiers.

15. The non-transitory computer-readable medium of claim 10, wherein wherein the private network has a private core separate from a public core.

16. The non-transitory computer-readable medium of claim 11, wherein the operations further comprise: receiving, from the SIM operating system (OS), a file path to the list of allowed or disallowed locations.

17. The non-transitory computer-readable medium of claim 11, wherein aborting the communication with the network precludes the wireless device from attempting to attach to the private network.

18. The non-transitory computer-readable medium of claim 11, wherein aborting the communication with the network prevents the wireless device from requesting a Radio Access Network (RAN) to connect the wireless device to the private network.

19. A non-transitory computer-readable medium storing instructions that when executed by a processor cause the processor to perform operations comprising:
receiving, at a wireless device, an authentication request for a private network;
determining a location of the wireless device;
determining whether the location of the wireless device is on a list of allowed or disallowed locations from a subscriber identification module (SIM) of the wireless device; and
in response to determining that the location of the wireless device is not listed as an allowed location, providing instructions to the SIM to abort communication with the private network.

20. The non-transitory computer-readable medium of claim 19, wherein aborting the communication with the private network precludes the wireless device from attempting to attach to the private network, wherein the private network has a private core separate from a public core.
